(19) United States
(12) Patent Application Publication
(10) Pub. No.: US 2011/0034341 A1
(43) Pub. Date: Feb. 10, 2011

(54) METHOD AND DEVICE FOR DETERMINING THE RELEVANCE OF SAMPLE ARRAY PREPARATIONS

(76) Inventors: Gábor Méhes, Graz (AT); Wolfgang Schmidt, Graz (AT); Christopher Wrighton, Lassnitzhohe (AT); Kurt Zatloukal, Graz (AT); Harald Zöbl, Wundschuh (AT); Peter Hecht, Graz (AT)

Correspondence Address: HAHN & VOIGHT PLLC, 1012 14TH STREET, NW, SUITE 620, WASHINGTON, DC, 20005, US

(21) Appl. No.: 12/095,545

(22) PCT Filed: Nov. 29, 2006
(86) PCT No.: PCT/AT2006/000492

§ 371 Date: May 24, 2010

(30) Foreign Application Priority Data
Nov. 30, 2005 (AT) A 1932/05

(51) Int. Cl. C40B 30/00; C40B 60/12

(52) U.S. Cl. 506/7; 506/39

(57) ABSTRACT

The invention relates to a method and a device (10) for determining the relevance of preparations (4) of sample arrays (1), containing a plurality of individual samples (3) at various positions. To produce a method or a device (10) that can be performed as quickly as possible and preferably without destroying the preparations (4), a device (11) is provided for non-destructive scanning of the preparations (4) of the sample arrays (1), which is connected to a database (12) that contains information on the positions of the individual samples (3) of the preparations (4) and to a computer unit (16) for processing the scanned preparations (4) and for generating data fields for each individual sample (3) and for selecting at least one parameter from each individual sample data field and for comparing this parameter or a value derived therefrom or a combination of parameters or values derived therefrom to at least one threshold value. Furthermore a device (17) for displaying the value of the comparison with at least one threshold value as a relevance criterion for the individual sample (3), and a memory (18) for storing this relevance criterion are also provided.

The invention relates to a method for determining the relevance of preparations of sample arrays, in particular tissue sample arrays, containing a number of individual samples at various positions.

In addition, the invention relates to a device for determining the relevance of preparations of sample arrays, in particular tissue sample arrays, containing a number of individual samples at various positions.

For purposes of diagnosis and research, it is common in medicine to collect various samples, for example tissue samples, and to subject them to various tests. In the case of tissue samples that were removed from human or animal organisms, it is common to embed them in paraffin and to extract cylindrical cores (so-called “cores”) at certain selected spots of the tissue samples and to insert them into cylindrical holes of a paraffin block of a corresponding size. Such tissue sample arrays (tissue microarrays, TMAs) are then usually cut with the help of a microtome, and the preparations are studied, for example, histologically.

To obtain important information as quickly as possible, in particular for diagnostic or therapeutic purposes, the above-described tissue sample arrays due to the large number of sections and individual samples are supplied to enhanced automatic analyses. For example, US 2003/0215936 A1 describes a method and a device for the study of such tissue sample arrays that is as quick and efficient as possible.

Although in the subsequent description, primarily tissue sample arrays are considered, this invention is not limited to such samples, but rather can be applied in the case of preparations of the most varied sample arrays, which contain a number of individual samples. In addition to human, animal and plant tissues, combinations of the most varied tissues with different origins are also suitable for use in this invention. Also, material, which was extracted from tissue, such as, e.g., proteins and nucleic acids, which are applied drop by drop to a glass support, can be examined with this invention. In addition, bodily fluids such as blood, saliva, etc., from living organisms can be analyzed. Finally, cultured cells or portions thereof but also organic or inorganic materials, which are arranged in the form of a sample array, can also be present as a preparation.

In the case of TMAs (tissue microarrays), the number of mostly cylindrical individual samples, which are introduced into the paraffin block, is usually in the range of several hundred individual samples. To be able to obtain as many individual sections as possible from a so-called target block, the introduced individual samples are to reach as uniformly deep as possible into the paraffin block. In practice, in the production of such tissue sample arrays, different depths of the samples in the paraffin block result because of cylindrical individual samples or “cores” of different lengths but also because of problems when introducing individual samples into the paraffin block, and thus in particular in sections of the paraffin block in deeper regions, it turns out that individual “cores” are only partially present or not present at all. For a reliable assessment of the following studies on the sections, it is therefore essential to determine the relevance of the section. In particular, an assessment should be able to be made, moreover, on whether individual samples are present or not at specific locations of the section.

Also, however, in other samples, it is of special importance to be able to make an assessment on the relevance of the individual samples in the preparation. On the one hand, this is of great importance for the reliability of the assessments, which are made after the sample is analyzed, in particular for diagnoses in the medical field. On the other hand, the preparations represent an enormous economic value, which can be increased if an assessment can be made on the relevance of the individual samples of the preparation.

Currently, such a monitoring of the relevance of preparations is performed in expensive manual methods on random samples of the preparations under a light microscope, whereby a selection of sections of a paraffin block is examined for the purpose of monitoring relevance. Here, the sections of the sample array that are used for examination are usually colored histologically to be able to detect missing individual samples more easily. For subsequent studies, these sections are no longer available because of the coloring. Moreover, such random sample-like studies provide no information on the actual relevance of the preparations between the random samples. This information would be enhanced namely by an increase in the number of random samples, but then fewer preparations would be available for subsequent studies. Moreover, the monitoring that is usually performed manually is very time-consuming and thus expensive.

An automatic scanning method, in particular for biological samples, with which automatic analyses of a large number of samples can be performed, is described in, for example, WO 02/101635 A1. For this purpose, a flat bed scanner is used in combination with an automatic image analysis. In this case, the analysis is conducted with sections of samples and not with sample arrays with a number of individual samples.

US 2004/0136581 A1 describes a method and a device for automatic analysis of images of a biological sample, whereby a biological sample that is prepared with a reagent is arranged on a microscope slide and scanned optically. Also, this analysis is not aimed at sample arrays with a number of individual samples. Moreover, the samples are influenced or even destroyed by the preparation.

Finally, WO 99/39184 A1 shows a device and a method for automatic image processing and analysis of biological samples arranged in microtiter plates. Even this analysis is not aimed at sample arrays with a number of individual samples.

The object of the present invention therefore is to provide an above-mentioned method for determining the relevance of preparations, which method can be performed as quickly as possible and as much as possible without destroying the preparations. The monitoring of relevance is to be automatable to obtain information on the relevance of the preparations of the sample arrays with the lowest possible costs and in the shortest possible time. The drawbacks of the prior art are to be avoided or at least reduced.

Another object of the present invention is to provide an above-mentioned device for determining the relevance of preparations of sample arrays, which device allows as quick and reliable a monitoring of relevance as possible and, moreover, is designed as simply and sturdily as possible and can be produced as economically as possible.

The first object according to the invention is achieved in that preferably each preparation is scanned in a non-destructive manner; data fields of each individual sample of the preparation are produced from the data that is obtained together with the positions of the individual samples in the preparation; at least one parameter is selected from each individual sample data field; and this parameter or a value derived therefrom or a combination of parameters or values derived therefrom is compared to at least one threshold value; and the comparison value is used as a relevance criterion for the individual sample; and any individual samples of the preparation whose relevance lies under a preset relevance boundary are identified as unusable; and in that the comparison value together with the position of the individual sample as well as the positions of all the unusable individual samples are stored together with a unique identification of the preparation.

The method according to the invention thus calls for any number of preparations or each preparation to undergo a monitoring of relevance, which is possible in that the preparations are preferably examined in a non-destructive manner and thus in addition are available for subsequent studies. For this purpose, a non-destructive treatment and scanning of each preparation and a collection of the corresponding data are carried out. The positions at which individual samples are present in the sample array can be the preset positions at which the individual samples of a sample array are to be arranged or the determined actual positions of the individual samples. Based on the positions at which individual samples should be or are present, the data in the data fields of each individual sample can be separated and these data fields can be fed to additional processing. For this additional processing, at least one parameter is selected, and the latter or a value derived therefrom or a combination of parameters or values that are derived therefrom are compared to at least one threshold value. The comparison value that is obtained for each individual sample is ultimately used as a relevance criterion for the individual sample, and the individual sample of the preparation is stored together with the position information. As a result of the method according to the invention, a data set thus exists that contains a relevance criterion for every individual sample of the preparation. In this case, it is important that not only a total assessment on the quality of the preparation be made, but rather an assessment on which individual samples are present or not. In the simplest case, this relevance criterion can be binary, i.e. to make only one assessment as to whether the individual sample is present or not. By such a monitoring of relevance performed on at most each preparation, those preparations for subsequent studies in which various individual samples are not present can also be used. The data that are obtained in the monitoring of relevance are incorporated for the subsequent, for example histological studies of the preparation, such that defective or absent individual samples in the preparation can be removed from the data that are obtained and thus cannot result in misinterpretations. Automatically performed analyses of the preparations by sample arrays, in particular tissue sample arrays, are possible only by such an additional data set, which makes a reliable assessment on the relevance of the preparation. The method for determining the relevance of preparations can be carried out directly before the study of the preparation that is performed or else at an earlier time, and the data are stored together with additional information on the preparations in a database, such that they are available for subsequent studies. As an alternative to the storage of the data in a database, the latter can also be archived in the so-called flat file format. By the method according to the invention, it is possible, for example, in the case of TMAs (tissue microarrays) to undergo a far greater number of subsequent studies on sections of sample arrays and thus to obtain more information from frequently limited tissue resources for diagnostic, therapeutic purposes, but also for research purposes. Thus, a data set exists that unambiguously identifies the individual samples that are considered to be unusable because of the monitoring of relevance. Thus, preparations with absent or unusable individual samples are also suitable for subsequent studies, since absent or destroyed individual samples are unambiguously identified and the data that result from subsequent studies of such individual samples can be discarded. Thus, more preparations of a sample array are available in subsequent studies, without the danger of misinterpretations existing. A combination of the non-destructive method according to the invention with other methods in which individual preparations are impaired or even destroyed is, of course, also possible to obtain important additional information as a result.

Advantageously, the preparation of sample arrays is scanned optically, and the image that is obtained is stored. The preparation is not influenced by such an optical method and is therefore available in addition for subsequent studies. Therefore, in principle all preparations of a study can be subjected to determining the relevance without the number of preparations that are available for subsequent studies being reduced. Moreover, the optical scanning is possible at especially high speed and also automated, by which a great number of preparations can be studied within a short time.

The preparations can be irradiated with light, and an image of the translucent light can be taken. This simple method comprises a light source and a camera or a flat bed scanner, which records the transferred light that goes through the preparation. In this way, for example, missing individual samples can be detected especially easily. In the transmitted light method, a negative of the captured image can be produced, by which the detection of missing or destroyed individual samples is facilitated because of contrast differences.

As an alternative or in addition to the transmitted light method, the preparations are preferably stimulated with light, in particular laser light, and an image of the resulting autofluorescence radiation is recorded and stored. The use of autofluorescence, i.e. the resulting radiation of elements that are stimulated with light of a specific wavelength, is another suitable examination method which does not destroy the sample. Specifically in the study of preparations of tissue sample arrays, in which usually individual, circular samples are embedded in paraffin, the autofluorescence study is especially suitable, since paraffin in contrast to common tissue samples causes less fluorescence radiation, and thus a clear contrast between the individual sample and the surrounding paraffin results. Because of this high contrast between individual samples and paraffin, the assessment as to whether an individual sample is present or not can be performed by especially simple image processing methods. The simpler the method of analysis, the less computer power is required to run an automatic monitoring of relevance test as quickly as possible.

In particular, in tissue samples from human or animal organisms, light sources of various wavelengths or light sources with a broader wavelength range, for example mercury lamps, and various filters can be used. In the case of a fluorescence microscope, for example, ultraviolet lamps and three different filters, for example with the following characteristics, are used.

| | Wavelength of the | Transmission range |
|---|---|---|
| Filter | exciting light | of the filter |
| Ultraviolet | 390 nm | 410 to 420 nm |
| Blue | 410 nm | 505 to 520 nm |
| Green | 515 nm | 560 to 610 nm |

In the case of fluorescence scanners, for example, lasers with two different wavelengths together with highly-specific fluorescence dyes, such as, e.g., CY3 (indocarbocyanine) or CY5 (indodicarbocyanine), are used. CY3 can, for example, be excited at 530 nm and emits light at a wavelength of 595 nm CY5 is stimulated at 630 nm and emits fluorescence radiation at 680 nm.

Better results can also be achieved when the preparation of the sample arrays is stimulated with combined light of different wavelengths. With such “multispectral imaging,” different light sources are used and thus more information is obtained. As light sources, for example, lasers such as argon ions or helium/neon lasers are available. Moreover, instead of lasers, light sources with a wide wavelength range can be used for detecting the presence or absence of individual samples. For example, mercury lamps or fiber-optic devices can be used as light sources.

To facilitate the subsequent processing of data, the images of the preparations are preferably stored in a standardized format, for example in TIFF or JPG format. This also makes possible the application of existing image processing programs and does not require any data conversion before the study.

Advantageously, the image of the preparation is transformed into at least one binary image. A binary image consists of a matrix of logical zeros and logical ones, from which the probability of the presence of an individual sample can be determined and thus an assessment can be made on the relevance of the individual sample. Such binary images are produced so that the parameter used is compared to a threshold value or several threshold values. If more than one parameter is used, several binary images can accumulate that can be combined in an algorithm at a later time.

The captured images of the preparations can be filtered according to various criteria. In this case, both mechanical filters, which are placed in front of the camera or the like to record the images, and electronic filters, through which image data pass, are used.

The fluorescence intensity, which averages the individual sample preferably via the cross-section and is used as a parameter to determine the relevance of the individual samples, can be used as a parameter that is selected from each individual sample data field and is used to determine the relevance of the preparations. For example, the fluorescence intensity can be detected in two directions, in particular in the two main axis directions via the normally circular cross-section of the individual sample, and an assessment on the relevance of the individual sample can be made from the resulting distribution. The data are compared to a preset threshold value, and then the comparison value is used as a relevance criterion for the individual sample. The respective threshold value can result from experimental values or can also be determined automatically by means of standardized statistical methods, for example the so-called box plot method. When using the fluorescence intensity as a parameter, the values are preferably put in a ratio with the intensity of the surrounding pixel, and a distribution of the fluorescence intensity over the pixels of the image is produced. For example, the variability in the fluorescence intensity or the like can be used as a derived value of a parameter.

In this case, the unusable individual samples of a preparation of the sample array can be added up. From this sum, an assessment on the number of still usable individual samples of a preparation can be made.

If the sum of the unusable individual samples of a preparation is compared to a preset boundary value, and the preparation of the sample array is identified as unusable when exceeding this boundary value, the preparation can be excluded from subsequent studies. This makes sense in an especially large number of unusable individual samples per section, since as a result, especially delicate, complex, and possibly also very expensive studies can subsequently be avoided.

Also, the preparation can be classified based on the determined sum of unusable individual samples, and a classification value can be stored together with a unique identification of the preparation. This important information can be used for subsequent studies of the preparation. For example, it may be advisable for really time-consuming and expensive studies to use only those preparations in which only a very small number of samples or no individual samples are unusable, which thus have especially high quality. However, in studies that can be performed quickly and inexpensively, a preparation can also be used with a large number of unusable individual samples, i.e. a low-quality preparation, and as a result can supply important information. The unique identification of the preparation can be provided by, for example, an identification number, which can also be arranged in the form of a bar code in addition to the preparation on, for example, a glass support. By reading the bar code, the information stored in a database can then be accessed regarding the relevance of the preparation and used for subsequent studies.

In addition to the above-mentioned method, a microscopic image of the preparation can also be recorded and used for determining relevance. Such microscopic images can contain additional advantageous information. The assessment on the relevance of the individual samples of the preparation can be enhanced by the superposition of the microscopic image with the image that results from, for example, the fluorescence radiation.

In addition or as an alternative to the fluorescence intensity, the geometric shape of the individual sample can also be determined from the individual sample data field and used as a parameter for determining the relevance of the individual samples. For example, the contour of the individual sample can be determined from the individual sample data field by various image recognition methods and compared to the ideal shape of the individual sample, for example a circle. In the case of an excessive deviation of the determined shape of the individual sample from the ideal shape, the latter can be discarded as unusable. For example, when introducing cylindrical samples into the paraffin block in the case of tissue sample arrays, at times deformations of the tissue samples result that can distort subsequent examination results.

To be able to perform the monitoring of relevance as quickly as possible, preferably several preparations are processed automatically sequentially or in parallel, and the data obtained on the relevance of the individual samples of the preparations are stored together with an identification of the preparations. Thus, as early as after the production of the preparations of sample arrays, data on the relevance of the preparations can be collected and stored. These data are then available for a selection of the preparations for specific, subsequent studies.

The theoretical positions of the individual samples in a preparation, in particular a tissue sample array, are preferably preset and stored. These position values can be used for the production of data fields of any individual samples of the preparation.

According to another feature of the invention, it is provided that the actual positions of the individual samples in a preparation are determined from an image of the preparation. This can be carried out by, for example, applying the so-called “region growing.” With the help of this mathematical method, specific pixels of the image, the so-called seed points, are preset by means of a random generator, and a specific number of surrounding pixels are included in the calculation. In this case, the intensity of the seed point is compared to the intensities of the surrounding points and incorporated in the calculation. The “region growing” method is suitable primarily for determining the sizes of surface areas, the number of surface areas, and the edge lengths of surface areas to match a curve to the edge of a surface, to calculate the center of gravity and higher moments as well as the circular variance or the elliptical variance. The determination of the actual position of the individual samples can be performed by application of the “region growing” method and subsequent methods for determining the center of the individual samples.

In addition, the actual positions of the individual samples can be compared to the stored, theoretical positions in any case, and the preset position data can be corrected appropriately in the case of deviation. With so-called “gridding,” the data are analyzed and are plotted on a grid that is usually rectangular. As a result, the case can occur that the production of, for example, sections of the sample arrays frequently results in a distortion of the grid of the individual samples. When the position of the individual samples is clearly secured, the relevance monitoring can also be performed reliably.

The second object according to the invention is also achieved by an above-mentioned device for determining the relevance of preparations of sample arrays in which a device is provided for non-destructive scanning of preparations of the sample arrays, which scanning device is connected to a database that contains information on the positions of the individual samples of the preparations and to a computer unit for processing the scanned preparations and for generating data fields for each individual sample and for selecting at least one parameter from each individual sample data field and for comparing this parameter or a value derived therefrom or a combination of parameters or values derived therefrom to at least one threshold value, and wherein a device for displaying the value of the comparison of at least one parameter or a value derived therefrom or a combination of parameters or values derived therefrom with at least one threshold value as a relevance criterion for the individual sample, and a memory for storing this relevance criterion together with the position of the individual sample of the preparation are provided. A device for determining the relevance of preparations of sample arrays according to this invention therefore usually consists of a computer unit, which is connected to a corresponding scanning device and accordingly processes the information that is obtained.

Here, the scanning device is preferably formed by a light source and a device for recording an image of the preparation. In the case of the transmitted light method, the light source is arranged above the preparation and the scanning device is arranged below the preparation, such that the scanning device can detect the light that shines through the preparation. In the case of autofluorescence, the light source and the scanning device are arranged above the preparation.

The recording device can be provided in the form of a fluorescence scanner, which records the fluorescence radiation of the preparation excited by a corresponding light source.

The light source can be formed by a laser, whereby the wavelength is matched to the respective conditions and the use of possible fluorochrome.

Also, several light sources can be provided in various wavelength ranges or else a light source that emits light in a very wide wavelength range.

In addition, a device for transformation of the recorded image of the section into at least one binary image can be provided.

To increase the relevance of the data obtained, a filter device can be provided to filter the recorded images of the preparations. As already mentioned above, these can be filters that are arranged in front of the recording device as hardware, but also filters that undertake a software adjustment of the data that is obtained.

In addition, a microscope can be provided to record preparations for producing additional information for determination of relevance.

To allow the fastest possible analysis, a device for automatic feed and exhaust of the preparations can be provided.

Also, a magazine for receiving a number of preparations can be provided, from which the preparations are removed and returned again in an automated manner for determination of relevance. Thus, a partially automated determination of relevance of the preparations can be achieved.

Preferably, a device for determining the actual positions of the individual samples in the preparation is provided. Thus, the real position of the individual samples, which frequently does not correspond to the desired position, can be determined in a reliable manner.

Finally, a device for correcting the positions of the individual samples in the preparation can be provided, which device is connected to a device for receiving the preparation for determining the actual positions of the individual samples. As a result, the distortions of the grid of the arranged individual samples that result usually when a sample array is cut can be corrected.

In what follows, the present invention is explained in more detail based on the attached drawings, wherein

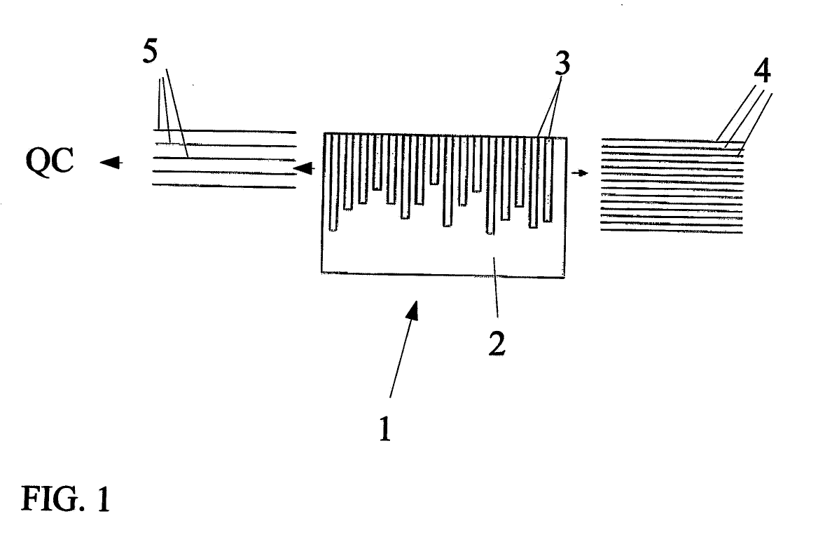

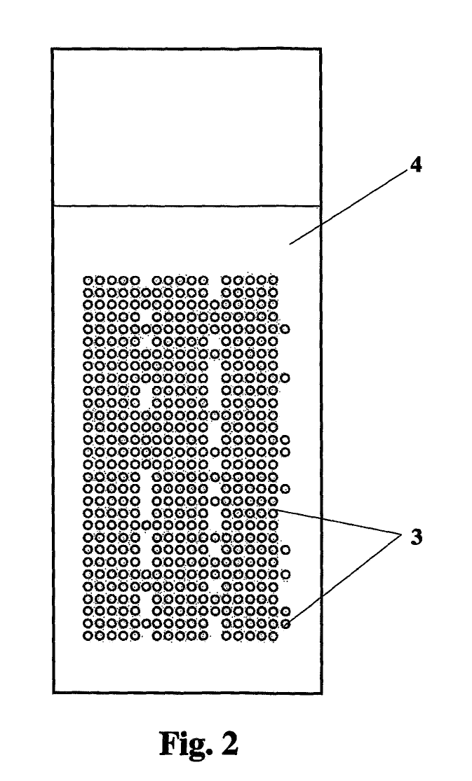

FIG. 1 shows a diagrammatic representation for illustrating the production of sections of sample arrays;

FIG. 2 shows the top view of an exemplary section of a sample array;

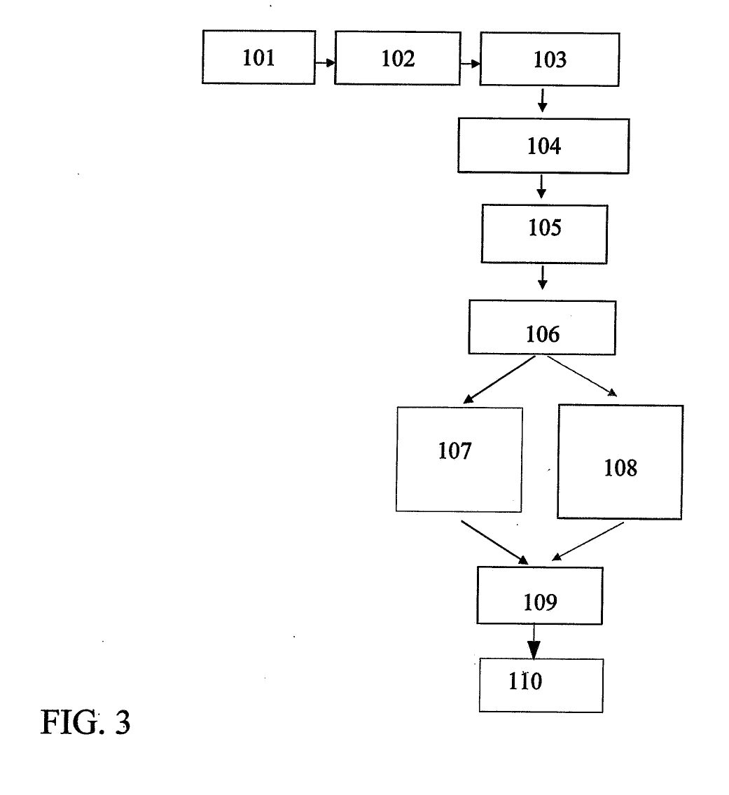

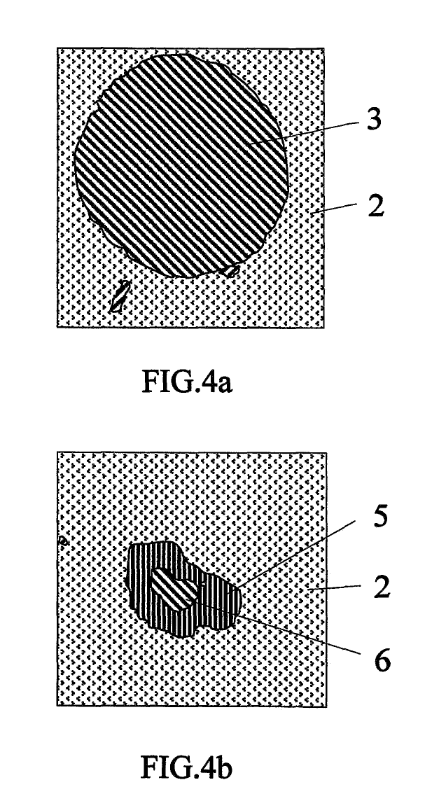

FIG. 3 shows a block diagram for illustrating the method for determining the relevance of preparations of sample arrays according to the invention;

FIGS. 4a and 4b show examples of a present and an absent or greatly damaged individual sample of a preparation;

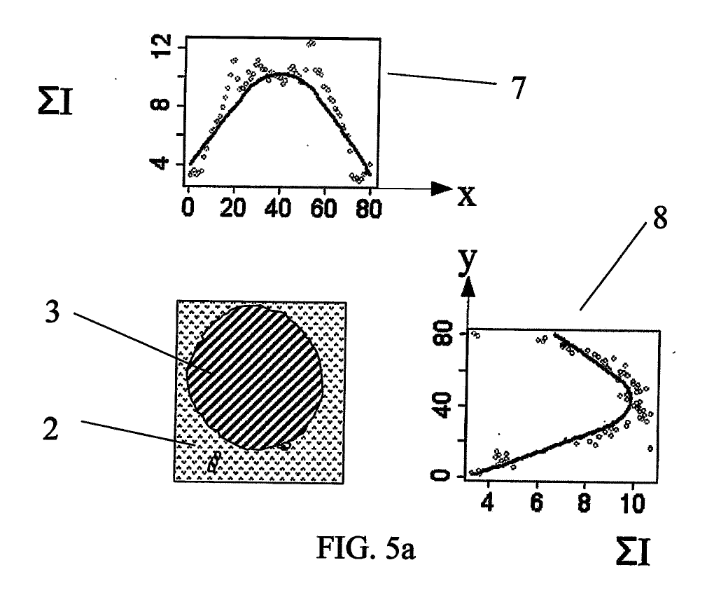

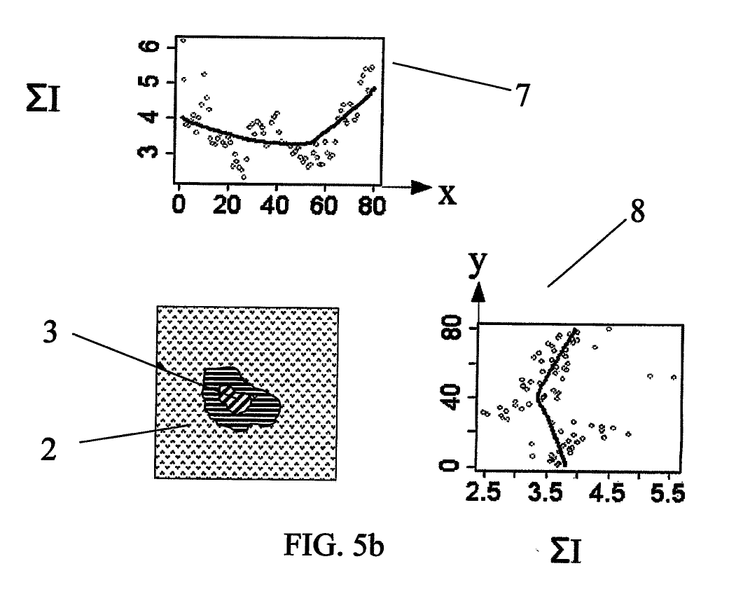

FIGS. 5a and 5b show the measurement results in the individual samples according to

FIGS. 4a and 4b with use of the fluorescence intensity as a parameter;

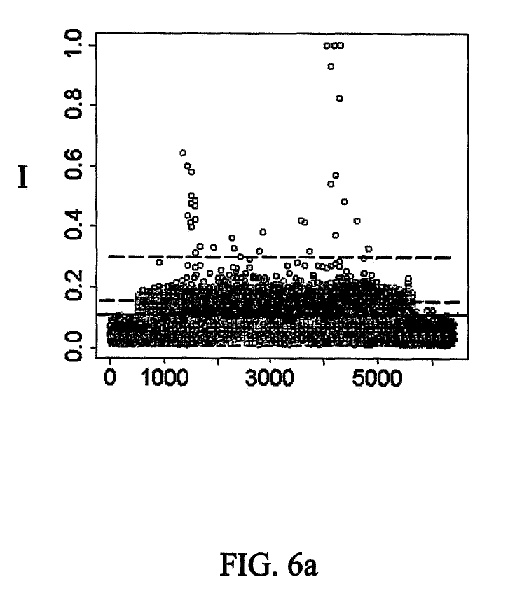

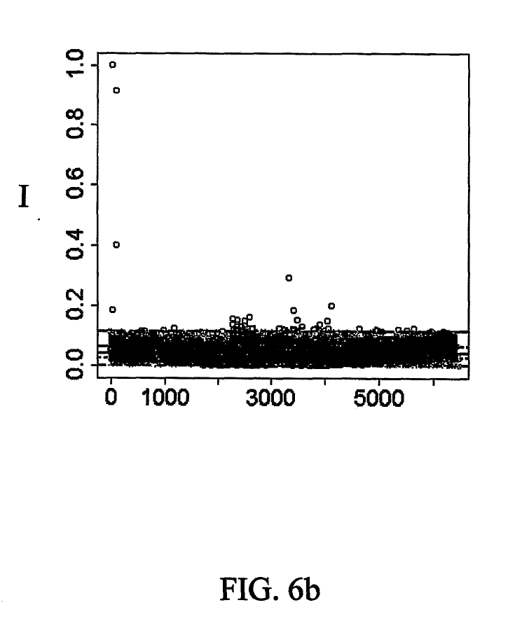

FIGS. 6a and 6b show two possible data sets of the individual samples according to FIGS. 4a and 4b;

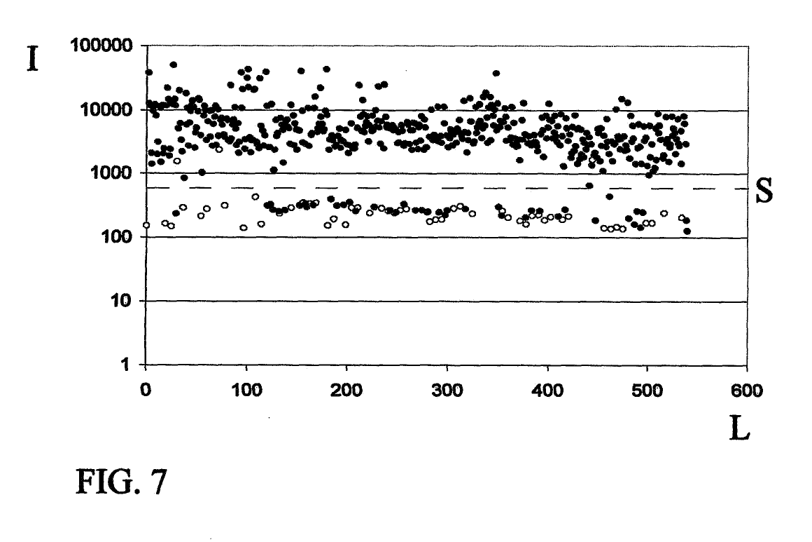

FIG. 7 shows the measurement result of another embodiment of the method according to the invention with use of autofluorescence; and

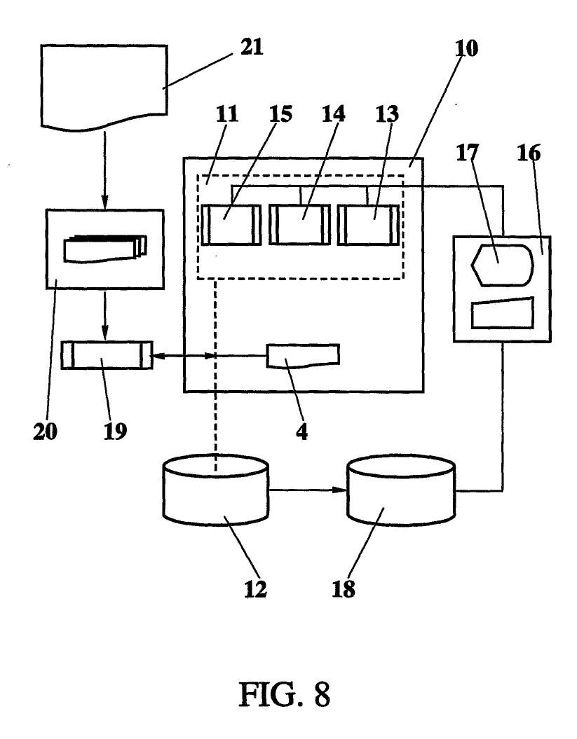

FIG. 8 shows a block diagram of an embodiment of the device for determining the relevance of preparations of sample arrays.

FIG. 1 shows a diagrammatic representation for illustrating the production of preparations 4 or sections from sample arrays 1, in particular tissue sample arrays (TMAs tissue microarrays). The sample array 1 consists of a parallelepiped paraffin block 2 into which individual cylindrical samples 3, in particular tissue samples, are introduced. Because of the different origin of the individual samples 3 but also because of mechanical problems when introducing the individual samples 3 into the paraffin block 2, the depth of the individual samples 3 in the paraffin block 2 is variable in practice. In the production of preparations 2 or sections from the sample array 1, which preferably is performed with a microtome, individual samples 3 at different positions are frequently missing, in particular in deeper regions of the sample array 1. These missing individual samples 3 in the preparations 4 are not available in subsequent histological or histopathological studies and thus reduce the information that is obtained from the studies. It is therefore very important to be able to make an assessment on the relevance of the preparations 4.

As depicted diagrammatically in the left image of FIG. 1, a selection of preparations 5 or sections of the sample array 1 is used for quality control (QC) according to the prior art. In this case, the preparations 5 are usually colored histologically, and an assessment on the presence or absence of an individual sample 3 in the preparation 5 is made based on the color differences in the microscopic image. After relevance monitoring, the preparations 5 are no longer available for other studies. This reduces the number of preparations 4 that are usable as a whole. Moreover, relevance monitoring performed according to the prior art offers a relatively unreliable piece of information, as for the preparations amongst the preparations 5 selected on a random-sample basis, no reliable assessments can be made on their relevance.

There is therefore a need for a method and a device for determining the relevance of the preparations 4 of a sample array 1, which are not destroyed by the monitoring of relevance and thus are available in addition for subsequent studies.

FIG. 2 shows a top view of a preparation 4 of a sample array 1, wherein the individual samples 3 are arranged in a specific pattern, which allows an unambiguous assignment of the individual sample 3. In the shown example, the columns are coded in binary form with a portion of the holes for the individual samples 3. Thus, after the production of preparations 4, it is not possible to confuse the individual samples 3, for example by rotation or twisting the glass support. The position of the individual samples 3 in the sample array 1 or in the preparation 4 is unambiguously assigned.

FIG. 3 shows a block diagram for illustrating the method according to the invention for determining the relevance of preparations 4 of sample arrays 1. Beginning with the production of a sample array 1 according to block 101, the preparations 4 from the sample arrays 1 are produced according to block 102. Then, according to block 103, the relevance monitoring is introduced without destroying the preparations 4. Corresponding to block 104, the preparations 4 of the sample arrays 1, containing a number of individual samples 3, are scanned in a non-destructive manner, resulting in a data field of the preparation 4. The non-destructive scanning of preparations 4 can be carried out, for example, in the transmitted light method and/or by application of autofluorescence. Corresponding to block 105, the information of the positions of the individual samples 3 in the preparation 4 is used to produce data fields of any individual sample 3 of the section 4. In this case, the theoretical position of the individual sample 3 in the preparation 4 or the actual positions of the individual samples 3 in the preparation 4 with the theoretical positions (according to the “gridding” method) that are determined after the comparison are used. These individual sample data fields are now processed according to block 106 in such a way that at least one parameter is selected from the individual sample data field, and this parameter or a value derived therefrom or a combination of parameters or values derived therefrom according to block 107 is compared to at least one threshold value, and the comparison value is used as a relevance criterion for the individual sample 3 and is stored together with the position of the individual sample 3 of the preparation 4. The result of the relevance monitoring obtained in block 107 can be merged with the results of additional studies of the preparation 4 according to block 108 and are subjected to an analysis in block 109. In the case of these results of additional studies of the preparation 4 that are produced in block 108, this can also involve different manually performed methods that produce additional information. Finally, the method according to block 110 is completed, and the data are stored. By the determination of relevance, important information is produced that enhances an interpretation of the data from the preparations 4 of the sample arrays 1 and allows a better use of the preparations 4.

In FIGS. 4a and 4b, examples of autofluorescence images of two individual samples 3 of a preparation 4 of a sample array 1 are shown. Here, diagrammatic representations of actual measurement results are considered. The individual sample 3 of FIG. 4a is almost ideally circular and unambiguously differs from the surrounding paraffin block 2. FIG. 4a shows the image of an individual sample 3 with especially high quality.

In contrast thereto, FIG. 4b shows a greatly deformed hole 5 in the paraffin block 2, in which a residue 6 of the individual sample 3 or of paraffin is present. This individual sample 3 is greatly deformed or not present at all and therefore is not available for subsequent studies.

FIGS. 5a and 5b show a variant of a method for determining the relevance of sample array sections with use of the individual samples 3 according to FIGS. 4a and 4b. In this case, for example, the fluorescence intensity I, whose distribution is evaluated depending on the x- and y-axis, is selected as a parameter. In Diagram 7, FIG. 5a shows the sum of the fluorescence intensity ΣI depending on the x-axis, and in Diagram 8, FIG. 5a shows the sum of the fluorescence intensity ΣI in the y-direction. The plots of Diagrams 7 and 8 indicate a turning point that shows a local maximum of the fluorescence intensity ΣI essentially in the middle of the individual sample 3. The intensity plots that correspond to Diagrams 7 and 8 can now be further processed, for example an average is formed and compared to one or more threshold value(s). This comparison value is used as a relevance criterion for the individual sample 3 and is stored, for example, in a database, together with the position information of the individual sample 3 of the preparation 4. From the intensity plots according to FIG. 5a, an especially high quality of the individual sample 3 shown according to FIG. 4a manifests.

However, the plots 7 and 8 of the fluorescence intensities I in x- and y-direction in the individual sample according to FIG. 5b are clearly different and show, on the one hand, a significantly lower intensity and, on the other hand, a plot that clearly deviates from the ideal case and can be used as a relevance criterion for the individual sample 3. In the shown example the plot of the fluorescence intensity I shows a local minimum in comparison to the individual sample 3 according to FIG. 5a. From the parameter of the fluorescence intensity I, an assessment on the relevance of the individual sample 3 in the preparation 4 of the sample array 1 can thus be made especially quickly and reliably.

FIGS. 6a and 6b show two additional possible data sets of the individual samples 3 according to FIGS. 4a and 4b. In this case, the autofluorescence intensity I is depicted based on the pixel of the image of the individual sample 3, i.e. the individual sample data field, and various values are calculated therefrom. These derived parameters, such as, e.g., extremal values, mean values, etc., as indicated by the horizontal lines, can be used as a relevance criterion for the individual sample 3. As can be gathered in the diagram according to FIG. 6b, the intensities I based on the location of the individual pixels of the data field of the individual sample 3 are clearly different from those according to FIG. 6a.

FIGS. 6a and 6b show the results of so-called box plot measurements. The rectangle determined by the quartile is referred to as a box that comprises 50% of the data. The interquartile interval can be read from the length of the box. This is an extent of variation, which is determined by the difference of the upper and lower quartile. As another quartile, the median (through-going line) is indicated. The additional, horizontal lines are designated as so-called whiskers, whose maximum length is 1.5× the interquartile interval and from which data can be determined. The uppermost and the lowermost lines indicated in broken form show the extremal values of the upper and lower whiskers. Values that lie beyond these limits are referred to as outliers and are used for determination of the relevance of the sample.

FIG. 7 shows another example of a simple determination of relevance according to this method, whereby the fluorescence intensity I is shown on the logarithmic scale based on the position L of the individual sample 3. In this case, the dark points show positions of the individual samples 3 or pixels of the image of the individual sample 3, in which material is present, and the white points show positions of the individual samples 3 without material. Black points below the manually-determined threshold value S indicate that material is not present for technical reasons. This is used as a relevance criterion for the individual sample 3. The determination of the threshold value S can also be determined automatically from the data of the preparation, whereby with so-called adaptive systems, a change in the threshold value can occur from one passage to another.

Finally, FIG. 8 shows a block diagram of a possible device 10 for determining the relevance of preparations 4 of sample arrays 1, containing a number of individual samples 3 at various positions. The device 10 has a unit 11 for non-destructive scanning of the preparations 4 of the sample arrays 1. The scanning unit 11 can be connected to a database 12 that contains information via the position of the individual samples 3 of the preparations 4. The scanning unit 11 is formed in particular by a light source 13, preferably a laser, and a device 14 for recording an image of the preparations 4. For additional information, a microscope 15 for recording an image of the preparations 4 can be arranged. The scanning unit 11 is connected to a computer unit 16 that correspondingly processes the data of the scanned preparations 4 and produces data fields for every individual sample 3. In the computer unit 16, a parameter is selected from each individual sample data field, and this parameter or a value derived therefrom or a combination of parameters or values derived therefrom is compared to at least one threshold value, and the comparison value is shown in a display device 17, for example a screen, and is stored in a memory 18 as a relevance criterion together with the position of the individual sample 3 of the preparation 4. For more efficient execution of the method for determining the relevance of the preparations 4, a device 19 for automatic feed and removal of the preparations 4 can be provided which is connected preferably to a reservoir 20 for receiving a number of preparations 4 that were removed from a corresponding repository 21.

Although in the examples, primarily tissue sample arrays (TMAs, tissue microarrays) are considered in detail, the present invention, as already mentioned above, can be used for the most varied sample arrays, containing a number of individual samples.

### Example of the Application of the Method to the Sections of a Tissue Sample Array

The method in question for determining the relevance of sample array preparations is suitable for identifying the available individual samples per preparation. In this example, a tissue sample array (TMA, tissue microarray) with respectively 450 individual samples or “cores” is studied. The tissue sample array contains 30 individual samples of a specific organ or tissue in each case, which are listed in the lines of the following table. By the method in question for determining the relevance of preparations of sample arrays, the number of individual samples per tissue can now be determined, which is essential for the following studies of these preparations. In this case, based on the respective position of the individual sample, it is determined which individual sample is not present or cannot be used. If, however, only the number of absent individual samples or destroyed individual samples was determined without their position, this would yield inadequate information in the case in question of a tissue microarray, since, for example, no assessment can be made regarding of which type of tissue more or fewer individual samples are present. The table below shows the application of the method according to the invention to two sections of a tissue sample array that consists of 450 individual samples made of 15 different tissues. In this case, each missing or destroyed individual sample is unambiguously identified, such that ultimately, the number of usable individual samples can be determined. Column 2 of the table shows the number of usable individual samples per type of tissue in section No. 4 of the tissue sample array. A total of 14 of 450 individual samples are defective and thus unusable or are missing and therefore also are not available for subsequent studies. Column 3 of the table shows the result for section No. 137 of the same tissue sample array. In this case, 223 of 450 individual samples are already destroyed or are absent. This clearly shows the above-described problem that many individual samples do not project so far into the paraffin block and thus are missing specifically in the deeper sections of the tissue sample array. For specific studies or for studies on specific types of tissue, however, with knowledge of this additional information, those sections can now also be used in which several individual samples are unusable, and the number of tissue samples, limited in the art, can be used in an optimum manner. For example, a study of the tissue samples of the cervix, breast or the ovary of section No. 137 is to be useful, since in this case, a majority of individual samples are present, whereas, for example, only four of 30 liver samples are present. The knowledge of the missing individual samples of a preparation can therefore be used to filter data for subsequent automated analyses.

Information on the patients is also usually present via each individual sample of the tissue sample array. For example, the 30 individual samples per type of tissue in the example in question originate from 10 different sources, i.e. for example, 10 different patients. Accordingly, 3 individual samples from the same source or the same patient in the ideal case exist. By the method according to the invention, the relevance of each individual sample of the preparation is determined, such that, for example, an assessment can be made on which type of tissue all 3 individual samples present in the ideal case can be used or of which, for example, only 2 or only 1 or even no individual sample can be used. For specific studies on the preparation, this information is, of course, of considerable importance. How the information obtained by the method according to the invention is processed, however, depends greatly on the respective application and the subsequent studies on the preparations.

TABLE

| | Section 4 | Section 137 |
|---|---|---|
| | number of | number of |
| Tissue | individual samples | individual samples |
| Stomach | 27 | 14 |
| Pancreas | 0 | 18 |
| Ovary | 0 | 22 |
| Breast | 0 | 23 |
| Cervix | 0 | 24 |
| Prostate | 24 | 7 |
| Testes | 30 | 16 |
| Kidney | 30 | 20 |
| Sarcoma | 29 | 14 |
| Endometrium | 29 | 13 |
| Thyroid Gland | 30 | 3 |
| Colon | 30 | 12 |
| Melanoma | 27 | 15 |
| Liver | 30 | 4 |
| Lung | 30 | 22 |
| SUM | 436 | 227 |
| Missing | 14 | 223 |

1. A method for determining the relevance of preparations (4) of sample arrays (1), in particular tissue sample arrays, containing a plurality of individual samples (3) at various positions, characterized in that preferably each preparation (4) is scanned in a non-destructive manner before predefined intense studies of the sample arrays (1); data fields of each individual sample (3) of the preparation (4) are produced from the data obtained together with the positions of the individual samples (3) in the preparation (4); at least one parameter is selected from each individual sample data field and this parameter or a value derived therefrom or a combination of parameters or values derived therefrom is compared to at least one threshold value, wherein said threshold value is selected on the basis of at least one inherent property of the individual samples (3), said property is to be examined within the predefined studies, and the comparison value is used as a relevance criterion for the individual sample (3) for said studies; and any individual samples (3) of the preparation (4), whose relevance lies under a preset relevance boundary value, are identified as unusable; and in that the comparison value together with the position of the individual sample (3) as well as the positions of all the unusable individual samples (3) are stored together with a unique identification of the preparation (4).

2. The method according to claim 1, wherein the preparation (4) is scanned optically, and the image is stored.

3. The method according to claim 2, wherein the preparation (4) is illuminated with light, and an image of the translucent light is recorded.

4. The method according to claim 2, wherein the preparation (4) is stimulated with light, in particular laser light, and an image of the resulting fluorescence radiation of the preparation (4) is recorded and stored.

5. The method according to claim 4, wherein the recorded image is filtered.

6. The method according to claim 4, wherein the preparation (4) is stimulated with combined light of various wavelengths.

7. The method according to claim 3, wherein the image of the preparation (4) is stored in a standardized format, for example in the TIFF or JPG format.

8. The method according to claim 3, wherein the image of the preparation (4) is transformed into at least one binary image.

9. The method according to claim 4, wherein the recorded images of the preparations (4) are filtered.

10. The method according to claim 1, wherein as the parameter, fluorescence intensity is averaged, preferably over the cross-section of the individual sample (3), and is used as the parameter for determining the relevance of the individual samples (3).

11. The method according to claim 1, wherein the unusable individual samples (3) of a preparation (4) are added up.

12. The method according to claim 11, wherein the sum of the unusable individual samples (3) of a preparation (4) is compared to a preset boundary value, and when this boundary value is exceeded, the preparation (4) of the sample array (1) is identified as unusable.

13. The method according to claim 11, wherein the preparation (4) is classified based on the determined sum of unusable individual samples (3), and a classification value is stored together with a unique identification of the preparation (4).

14. The method according to claim 1, wherein a microscopic image of the preparation (4) is recorded and is used for determination of relevance.

15. The method according to claim 1, wherein the geometric shape of the individual sample is determined from the individual sample data field and is used as a parameter to determine the relevance of the individual samples (3).

16. The method according to claim 1, wherein several preparations (4) are processed automatically sequentially or in parallel, and the data obtained on the relevance of the individual samples (3) of the preparations (4) are stored together with an identification of the preparations (4).

17. The method according to claim 1, wherein the positions of the individual samples (3) in a preparation are preset and stored.

18. The method according to claim 1, wherein the actual positions of the individual samples (3) on a preparation (4) are determined from an image of the preparation (4).

19. The method according to claim 18, wherein the actual positions of the individual samples (3) are compared to the stored positions, and in the case of deviation, the stored position data are corrected appropriately.

20. A device (10) for determining the relevance of preparations (4) of sample arrays (1), in particular tissue sample arrays, that contain a plurality of individual samples (3) at various positions, characterized in that a device (11) for non-destructive scanning of the preparations (4) of the sample arrays (1) before predefined intense studies of the sample arrays (1) is provided, said scanning device (11) is connected to a database (12) that contains information on the positions of the individual samples (3) of the preparations (4) and to a computer unit (16) for processing the scanned preparations (4) and for generating data fields for each individual sample (3) and for selecting at least one parameter from each individual sample data field and for comparing this parameter or a value derived therefrom or a combination of parameters or values derived therefrom to at least one threshold value, said threshold value is selected on the basis of at least one inherent property of the individual samples (3), said property is to be examined within the predefined studies; and in that a device (17) is provided for displaying the value of the comparison to at least one threshold value as a relevance criterion for the individual sample (3) for said studies, and a memory (18) is provided for storing this relevance criterion together with the position of the individual sample (3) of the preparation (4).

21. The device according to claim 20, wherein the scanning device (11) is formed by a light source (13) and a device (14) for recording an image of the preparation (4).

22. The device according to claim 21, wherein the recording device (14) is formed by a fluorescence scanner.

23. The device according to claim 21, wherein the light source (13) is formed by a laser.

24. The device according to claim 21, wherein several light sources (13) are provided in various wavelength ranges.

25. The device according to claim 21, wherein a device for transforming the recorded image of the preparation (4) is provided in to at least one binary image.

26. The device according to claim 21, wherein a filter device is provided for filtering the recorded images of the preparations (4).

27. The device according to claim 20, wherein a microscope (15) is provided for recording preparations (4) for producing additional information for determination of relevance.

28. The device according to claim 20, wherein a device (19) is provided for automatic feed and exhaust of the preparations (4).

29. The device according to claim 20, wherein a magazine (20) for receiving a number of preparations (4) is provided, from which the preparations (4) are removed and returned again in an automated manner for determination of relevance.

30. The device according to claim 20, wherein a device for determining the actual position of the individual samples (3) in the preparation (4) is provided.

31. The device according to claim 20, wherein a device for correcting the positions of the individual samples (3) in the preparation (4) is provided, said correcting device is connected to a device for recording the preparation (4) to determine the actual positions of the individual samples (3).
